(19) United States
(12) Patent Application Publication
(10) Pub. No.: US 2008/0232779 A1
(43) Pub. Date: Sep. 25, 2008

(54) IMAGE TAKING APPARATUS AND IMAGE REPRODUCTION APPARATUS

(75) Inventor: Hiroshi ENDO, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/051,617

(22) Filed: Mar. 19, 2008

(30) Foreign Application Priority Data
Mar. 23, 2007 (JP) 2007-076819

(51) Int. Cl. H04N 5/00; H04N 5/228

(52) U.S. Cl. 386/117; 348/222.1; 348/333.01; 386/E05.072; 348/E05.022

(57) ABSTRACT

In an image taking apparatus, when a sound detecting mode is selected, a sound from the object side is picked up by a microphone at the time of shooting and the volume of the sound is recorded by being associated with the shot image. At the time of reproduction, images each having a sound of not less than a certain volume are displayed.

### BACKGROUND OF THE INVENTION

1. Field of the Invention

The present invention relates to an image taking apparatus equipped with an imaging element, which generates image signals by forming an object image on the imaging element, and an image reproduction apparatus that reproduces and displays an image based on the image signals.

2. Description of the Related Art

Recently, there have appeared imaging elements capable of generating as many as 60 frames of six million pixels in one minute. If continuous shooting is performed by using such an imaging element, massive amounts of images are stored in a recording medium. Due to this, in the future, it will become an important issue to be able to realize an efficient way to retrieve images a user wants to watch from among these massive amounts of images.

Incidentally, many of the recent digital cameras or the like are equipped with a microphone so that they can record a sound along with a motion picture by picking up the sound at the time of shooting the motion picture. Japanese Patent Application Publication No. 10-243351 describes a technique that records a sound at the time of shooting a motion picture and utilizes the sound to adjust reproduction speed. Japanese Patent Application Publication Nos. 2000-23962 and 2004-80622 describe a technique that creates a digest or a summary of video by utilizing sound.

However, even though any of the techniques described in these patent application publications are applied, it is still impossible to efficiently retrieve images the user wants to watch from among enormous amounts of images.

### SUMMARY OF THE INVENTION

The present invention has been made in view of the above circumstances and provides an image taking apparatus capable of recording enormous volumes of images by adding useful information to each of the images for retrieving a required image from among the enormous volumes of images, and also provides an image reproduction apparatus capable of displaying a required image retrieved from among the enormous volumes of images by referring to object-side information of the image taken by the image taking apparatus.

A first image taking apparatus according to the present invention is an image taking apparatus that generates an image of an object by forming the image on an imaging element, the image taking apparatus including:

a microphone that picks up a sound at the time of shooting;

a detecting section that detects a characteristic volume of the sound picked up by the microphone at the time of shooting; and

a recording section that records the characteristic volume of the sound detected by the detecting section by associating the characteristic volume with the image.

According to the first image taking apparatus, at the time of shooting still images, it is possible to record the characteristic volume of the sound detected by the detecting section by associating the characteristic volume with the image. That is, a still image is recorded by making the characteristic volume of the sound as index. As a result, during reproduction, it is possible to retrieve desired images efficiently from among enormous volumes of images by using the characteristic volume of the sound as index.

Further, a second image taking apparatus according to the present invention is an image taking apparatus that generates image data representing an image of an object by forming the image on an imaging element, the image taking apparatus including:

a single shooting mode and a continuous shooting mode;

a microphone that picks up a sound at the time of shooting;

a detecting section that detects a characteristic volume of the sound picked up by the microphone; and

a recording section that records, in the continuous shooting mode, a characteristic volume of a sound acquired by the detecting section per shooting while plural images are continuously shot, by associating the characteristic volume with each of the plurality of images shot continuously.

According to the second image taking apparatus, in the continuous shooting mode, each characteristic volume of the sound at the time of shooting is associated with each of the plurality of images and recorded by the recording section. With this, even though a continuous shooting that produces enormous amounts of images is performed in the continuous shooting mode faster than before, it is possible to reproduce only a required portion of images by specifying a feature of the sound.

Here, it is preferable that the detecting section detects a volume of the sound picked up by the microphone as the characteristic volume.

With this, it is possible to record an image associated with a volume of the sound such as a person's voice or a crashing sound of objects.

Also, it is more preferable that the apparatus further includes a display screen and a volume displaying section that displays on the display screen a volume of the sound detected by the detecting section at the time of shooting.

Moreover, the detecting section may detect an average frequency of the sound picked up by the microphone as the characteristic volume.

An image reproduction apparatus according to the present invention is an image reproduction apparatus including:

an image acquiring section that acquires an image; and

a display screen that displays the image acquired by the image acquiring section,

wherein the image acquiring section acquires plural images each associated with each characteristic volume of a sound, and

the image reproduction apparatus further includes:

an image retrieving section that retrieves an image from among the images acquired by the image acquiring section based on the characteristic volume associated with the image, and

an image reproducing section that displays on the display screen the image retrieved by the image retrieving section.

According to the image reproduction apparatus of the present invention, for example, if the image acquiring section is constituted of the image taking apparatus of the present invention, an image can be retrieved by the image retrieving section based on the characteristic volume of the sound from among numerous volumes of images acquired by the image acquiring section and further, the image can be displayed by the image displaying section.

As a result, for example, if a certain characteristic volume of the sound is specified, then an image can be retrieved based on the certain characteristic amount of the sound and displayed on the display screen.

Here, in the image reproduction apparatus according to the present invention, it is preferable that the image displaying section arranges plural images acquired by the image acquiring section in the order of shooting, displays on the display screen images retrieved by the image retrieving section from among the plurality of images, and also displays images obtained by thinning-out of images that are not retrieved by the image retrieving section.

This additional feature makes it possible to display only a required image during reproduction even though numerous volumes of images are acquired by continuous shooting at the time of shooting.

Here, since there may be a case in which the linkage between the entire images may be lost if the images that are not retrieved are thinned out, the image displaying section may display on the display screen images retrieved by the image retrieving section from among the plurality of images acquired by the image acquiring section, and also may display images that are not retrieved by the image retrieving section in a size smaller than the retrieved images.

Further, the image acquiring section may acquire plural images with each of which the volume of a sound is associated as the characteristic volume of the sound and the image retrieving section may retrieve an image based on the volume of the sound.

Moreover, the image acquiring section may acquire plural images with each of which an average frequency of the sound is associated as the characteristic volume of the sound and the image retrieving section may retrieve an image based on the average frequency of the sound.

Furthermore, it is more preferable that the apparatus further includes a sound setting section that sets, according to a user operation, an average frequency of a sound that becomes a base for retrieving an image in the image retrieving section.

As described above, it is possible to provide an image taking apparatus capable of recording enormous volumes of images by adding useful information to each of the images for retrieving a required image from among the enormous volumes of images, and to realize an image reproduction apparatus capable of displaying a required image retrieved from among the enormous volumes of images by referring object-side information of the image taken by the image taking apparatus.

### BRIEF DESCRIPTION OF THE DRAWINGS

FIG. 1 is a diagram illustrating the structure of a digital camera according to a first embodiment of the present invention.

FIG. 2 is a block diagram illustrating an internal structure of the digital camera shown in FIG. 1.

FIG. 3 is a diagram illustrating an internal structure of a digital signal processing section 123 shown in FIG. 2.

FIG. 4 is a flowchart showing steps of shooting processing performed by a CPU 100.

FIG. 5 is a diagram showing a second embodiment.

FIG. 6 is a diagram showing a third embodiment.

FIG. 7 is a diagram showing reproduced images displayed on a liquid crystal monitor 125A when the processing shown in FIG. 6 is performed.

FIG. 8 is a diagram images processing for reproducing and displaying images associated with sound data of not less than a certain level in a sound detecting mode as well as reproducing and displaying images associated with sound data of less than the certain level by thinning them out.

FIG. 9 is a diagram showing an example of the screen displayed on the liquid crystal monitor when the CPU 100 performs the processing in FIG. 8.

FIG. 10 is a diagram showing processing when a frequency of a sound is set as a characteristic volume of the sound.

FIG. 11 is a diagram showing an example that displays a required image in large size and an image that is less required in small size.

FIG. 12 is a diagram showing how images are displayed on the display screen when the CPU performs the processing in FIG. 11.

FIG. 13 is a diagram illustrating a display example when a bar that indicates the volume of a sound with its length is shown on the liquid crystal monitor along with images.

### DETAILED DESCRIPTION OF THE INVENTION

Embodiments of the present invention will be described below with reference to the accompanying drawings.

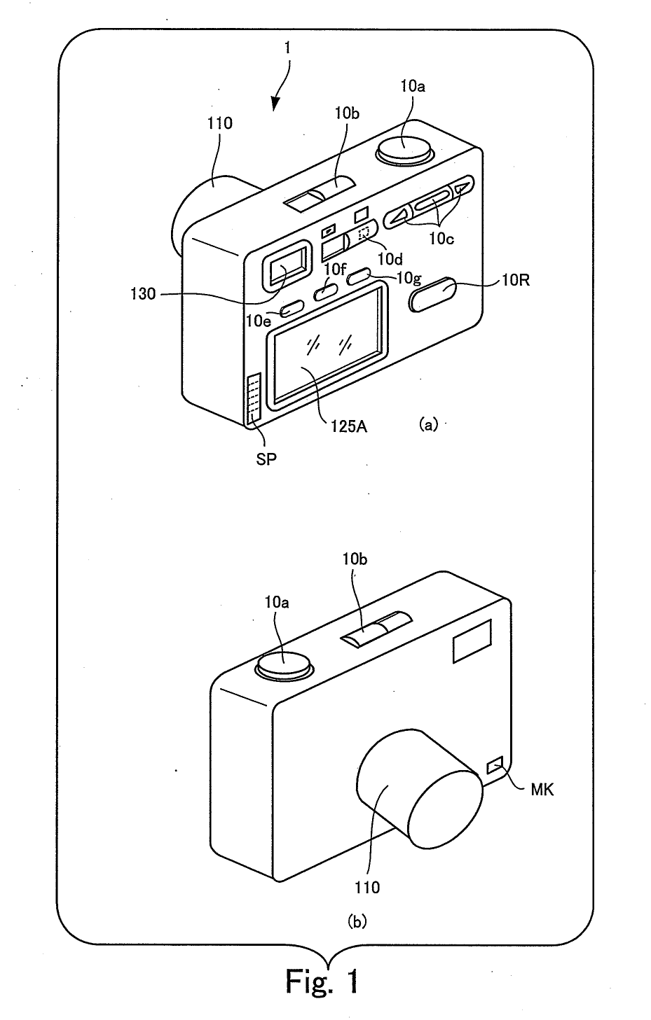

FIG. 1 is a diagram illustrating the structure of a digital camera 1 according to the first embodiment.

Part (a) of FIG. 1 shows the backside of the digital camera 1 seen diagonally from above and Part (b) of FIG. 1 shows the front of the digital camera 1 seen diagonally from above.

As shown in FIG. 1, a lens barrel 110 equipped with a built-in shooting lens is disposed at the front of a main unit (in Part (a) of FIG. 1, the upper left slanting direction is the front) and a release button 10a and a power switch 10b are disposed on the upper surface of the main unit. On the backside of the main unit shown in Part (b) of FIG. 1, a liquid crystal monitor 125A, a finder eyepiece 130, all-purpose keys 10c, an operation mode selection switch 10d, a menu button 10e, a cancel button 10f, a display button 10g, a function button 10R and the like are disposed. In addition, a speaker SP is disposed next to the liquid crystal monitor 125A.

The digital camera 1 in FIG. 1 functions as one example of the image taking apparatus according to the present invention once the operation mode selection switch 10d is switched to the shooting mode. And it functions as the image reproduction apparatus according to the present invention once the operation mode selection switch 10d is switched to the reproducing mode. When it functions as the image reproduction apparatus according to the present invention, a shooting function in the shooting mode serves as the image acquiring section according to the present invention.

There is a microphone MK provided on the lower front of the main unit of the digital camera 1 in the present embodiment in FIG. 1. The digital camera 1 is configured to be capable of picking up sound from the object side by the microphone MK at the time of shooting. Although the details will be described later, the digital camera 1 in the present embodiment has a sound detecting mode for detecting sound regardless of whether the shooting mode or the reproducing mode is set. When the sound detecting mode is selected by the operation of the menu button 10e and the generic keys 10c or the like, then in the shooting mode, the microphone MK picks up a sound and sound data representing the sound is associated with a shot image and recorded, while in the reproducing mode, a shot image is retrieved based on the sound data and reproduced to be displayed.

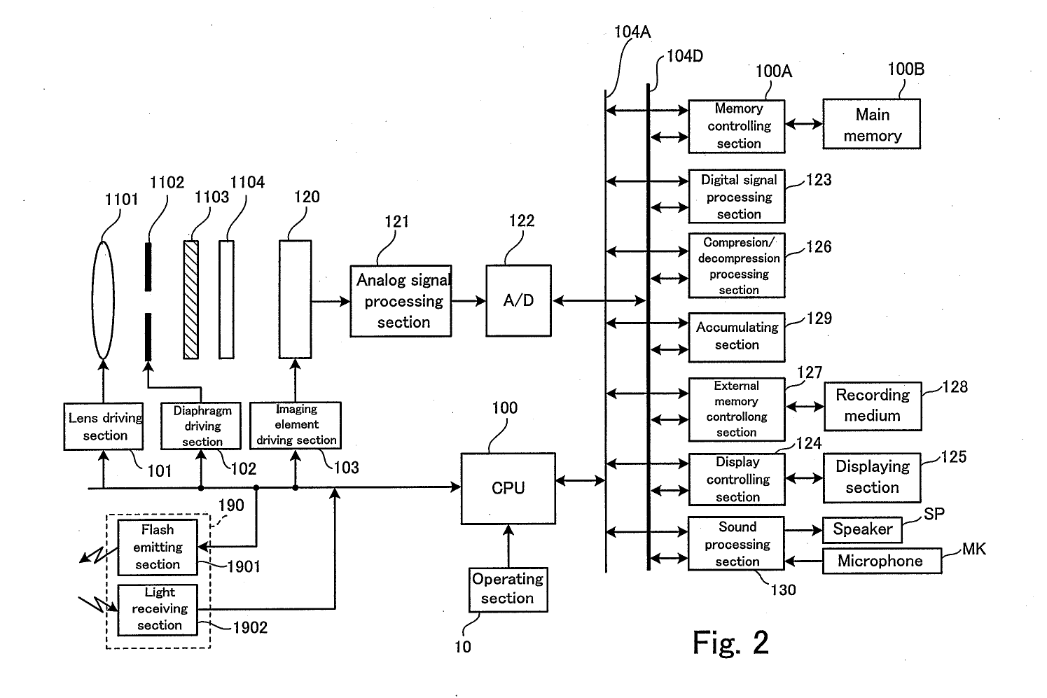

FIG. 2 is a block diagram illustrating an internal structure of the digital camera 1 shown in FIG. 1.

As shown in FIG. 2, a CPU 100 controls the entire operation of the digital camera 1 in the present embodiment. To the CPU 100, a main memory 100B that stores programs is connected through an address bus 104A and a data bus 104D. In the digital camera 1 of the present embodiment, upon power-on, the CPU 100 accesses the main memory 100B via a memory controlling section 101A and starts the control of the operation of the digital camera 1 by following the steps of internal programs.

Here, the structure of the digital camera 1 will be described in the order along the flow of image data.

Since image data representing an image of an object captured by a shooting lens 1101 shown at the left side in FIG. 2 is recorded in a recording medium 128 shown at the right side, the description will start sequentially from elements shown at the left side in FIG. 2.

An image of the object captured by the shooting lens 1101 in a shooting optical system shown at the left side in FIG. 2 is formed in an imaging element 120. At the time, it is necessary to form in the imaging element 120 an image of light from the object of which focus and exposure are adjusted. Therefore, under the control of the CPU 100, based on a result of accumulation obtained by an accumulating section 129 (described later), a shutter speed and a diameter of the diaphragm of the electronic shutter are controlled by a diaphragm driving section 102 and an imaging element driving section 103 to adjust exposure, and the focus position inside the shooting lens 1101 is adjusted by a lens driving section 101 to sharpen the focus.

In the present embodiment, occurrence of aliasing is suppressed by interposing an optical low pass filter 1104 into the shooting optical system equipped with the shooting lens 1101 or adverse influence caused by infrared way is prevented by interposing an infrared cut filter 1103, since the sensitivity on the infrared side of the imaging element 120 (a CCD solid state imaging element in this example) is high.

In this way, the image of the object to which the shooting lens 1101 is directed is formed in the imaging element 120 and image data representing the image of the object is generated in the imaging element 120 and outputted from there to an analog signal processing section 121.

In the digital camera such as the one shown in FIG. 1, the liquid crystal monitor 125A on the backside is used instead of a finder so that, upon power-on, the CPU 100 directs the imaging element driving section 103 to generate images in the imaging element 120 at certain time intervals and to output image data to the analog signal processing section 121 so that a motion picture can be displayed on the liquid crystal monitor 125A. Upon receipt of the image data outputted from the imaging element 120, the analog signal processing section 121 performs noise reduction processing or the like and the image data after the noise reduction processing is converted into image data of digital signal at an A/D converting section 122 in the later stage and guided onto the data bus 104D.

First of all, all the image data guided onto the data bus 104D is transferred into a frame memory within a digital signal processing section 123. At this digital signal processing section 123, processing such as conversion of RGB signal into YC signal is performed and the image data converted into YC signal is transferred to a display buffer memory (not shown) within a display controlling section 124 under the control of the CPU 100. Then an image based on the image data is displayed on the liquid crystal monitor 125A provided in a displaying section 125 under the control of the display controlling section 124. The CPU 100 orders the imaging element driving section 103 to generate images and output image data in the imaging element 120 at certain time intervals as described previously, so that the content of the image buffer memory within the display controlling section 124 is rewritten at certain time intervals and the image of the object captured by the shooting lens 1101 (hereinafter, called as a through image) is displayed on the liquid crystal monitor 125A provided in the displaying section 125.

Here, if the release button 10a is pressed by the user at the right moment to take a photo while watching the through image on the liquid crystal monitor 125A, then firstly when the release button 10a is half pressed, the CPU 100 makes the accumulating section 129 perform photometric measurement and distance measurement and receives the results of the photometric measurement and distance measurement to set a shutter speed for the diaphragm driving section 102 as well as directs the lens driving section 101 to move the focus lens to the in-focus position.

Next, when the release button 10b is completely pressed, the CPU 100 causes the imaging element driving section 103 to reset accumulated charges based on a result of accumulation calculated in the accumulating section 129 and causes the imaging element 120 to carry out exposure and close a shutter 1102 (which also serves as a diaphragm) after a lapse of certain shutter time (second). Then the CPU 100 directs the imaging element driving section 103 to supply image reading signals toward the imaging element 120 so that the image data representing an image of the object is outputted to the analog signal processing section 121. In addition, at this point, when the CPU 100 determines that the field luminance is dark, shooting is performed by causing a flash emitting section 190 to fire a flash. Additionally in this example, the flash emitting section 190 having a feature of light adjustment is illustrated as an example, which is configured to stop emission when light emitted from a light emitting section 1901 and received at a light receiving section 1902 reaches a certain light quantity. When the image data outputted from the imaging element 120 is supplied to the analog signal processing section 121, then noise reduction processing and other processing are performed at the analog signal processing section 121, and the image data converted into digital signal at the A/D converting section 122 is all guided onto the bus 104D, and the image data guided onto the bus side is all guided into the frame memory within the digital signal processing section 123.

At the digital signal processing section 123, signal processing such as YC conversion processing is performed, and after the signal processing is performed at the digital signal processing section 123, the image data is transferred to a compression decompression processing section 126 based on addressing by the address bus via the data bus 104D, and the image data is subjected to compress processing at the compression decompression processing section 126. Further, the compressed image data is transferred to an external memory controlling section 127 in the same way and recorded in the recording medium 128 under the control of the external memory controlling section 127. In addition, although the details will be described later, when the previously described sound detecting mode is selected, the data representing a volume of the sound detected by the microphone MK is recorded by associating it with the image.

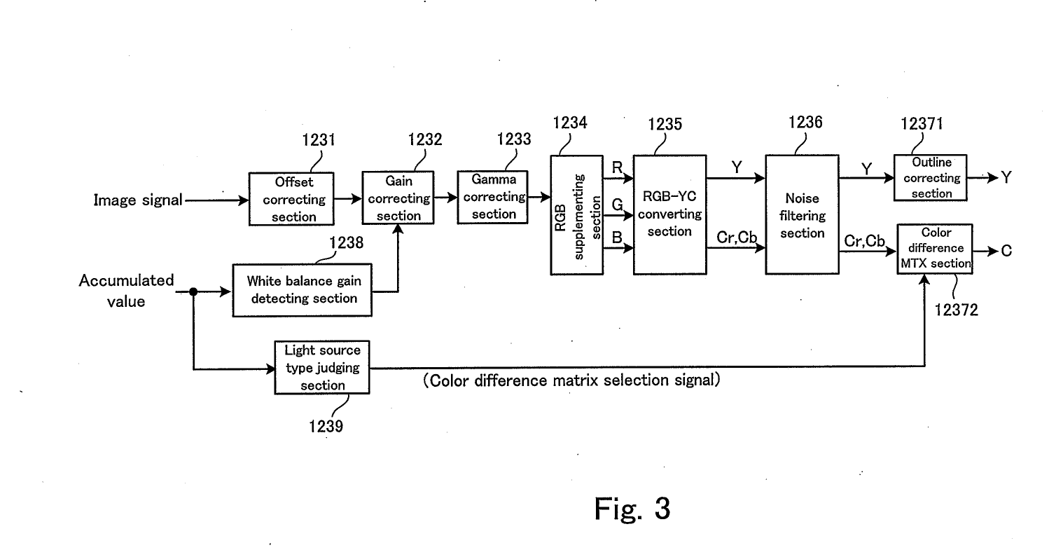

Here, an internal structure of the digital signal processing section 123 will be briefly described by referring to FIG. 3.

FIG. 3 is a diagram illustrating the internal structure of the digital signal processing section 123 shown in FIG. 2.

With reference to FIG. 3, description will be made about what kinds of processing is performed at the digital signal processing section 123, starting from an offset correcting section at the left side that corresponds to the input side.

Firstly, image signal is supplied to an offset correcting section 1231. In this offset correcting section 1231, the processing of clamping to a black label that is a base level of the supplied image signal is performed.

On the other hand, to a white balance gain calculating section 1238 and to a light source type judging section 1239, an accumulated value of each color pixel of the whole image represented by the image signal obtained at the accumulating section 129 is supplied. In the white balance gain calculating section 1238, a gain for adjusting white balance is calculated according to the accumulated value, and the calculated gain is set to a gain correcting section 1232 so that the gain correcting section 1232 can adjust white balance of the image signal. Also in the light source type judging section 1239, a light source type is judged from the accumulated value of each of the above color pixel, and the judged light source type is supplied to a color difference MTX section 12372 in the last stage. The color difference MTX section 12372 is configured to select a color difference matrix suitable for a light source according to the supplied light source type.

The image signal of which the white balance has been adjusted in the gain correcting section 1232 is supplied to a gamma correcting section 1233 in the later step, and processed by the gamma correcting section 1233 to become a luminance curve according to a gamma property of the liquid crystal monitor 125A. Then in a RGB supplementing section 1234, supplementing processing is applied to signals for R pixel, G pixel and B pixel, respectively. For example, for R pixel, the supplementing processing is performed based on the signals of G pixel and B pixel and the result is supplied to a RGB-YC converting section 1235 in the next step. In this RGB-YC converting section 1235, the conversion of RGB into YCC is performed by conversion matrix. Further, noise is removed in a noise filtering section 1236 in the later step; Y signal is supplied to an outline correcting section 12371; C signal is supplied to the color difference MTX section 12372; YC signal composed of the Y signal and the C signal is supplied to the display controlling section 124 in FIG. 2. Besides, when image signal is recorded in the recording medium 128 by performing the signal processing in the digital signal processing section 123 in response to the release operation, the compression processing is performed in this digital signal processing section 123 and the compressed image signal is supplied to the external memory controlling section 127.

Returning to FIG. 2, description will be made about other elements provided in the digital camera.

In the present embodiment, there is provided a sound processing section 130 that signal-processes the sound picked up by the microphone MK that has been described by referring to FIG. 1. The sound processing section 130 is also quipped with a driving section that drives the speaker SP and is capable causing the speaker SP to output sound.

This sound processing section 130 includes a sound trap section, a filtering section such as a bandwidth pass filter, a level detecting section that detects a sound level, a sound recording section and the like. Therefore in the present embodiment, as described previously, when the sound detecting mode is selected, a volume of the sound is detected by using the level detecting section as a characteristic volume of the sound picked up by the microphone MK, and the data representing the volume of the detected sound is recorded in the sound recording section, and after shooting an image, the sound data is transferred to the external memory controlling section 127 so that the date representing the volume of the sound associated with the image at the time of shooting can be recorded.

Description will be made about the shooting processing when the digital camera 1 configured as described above performs a shooting.

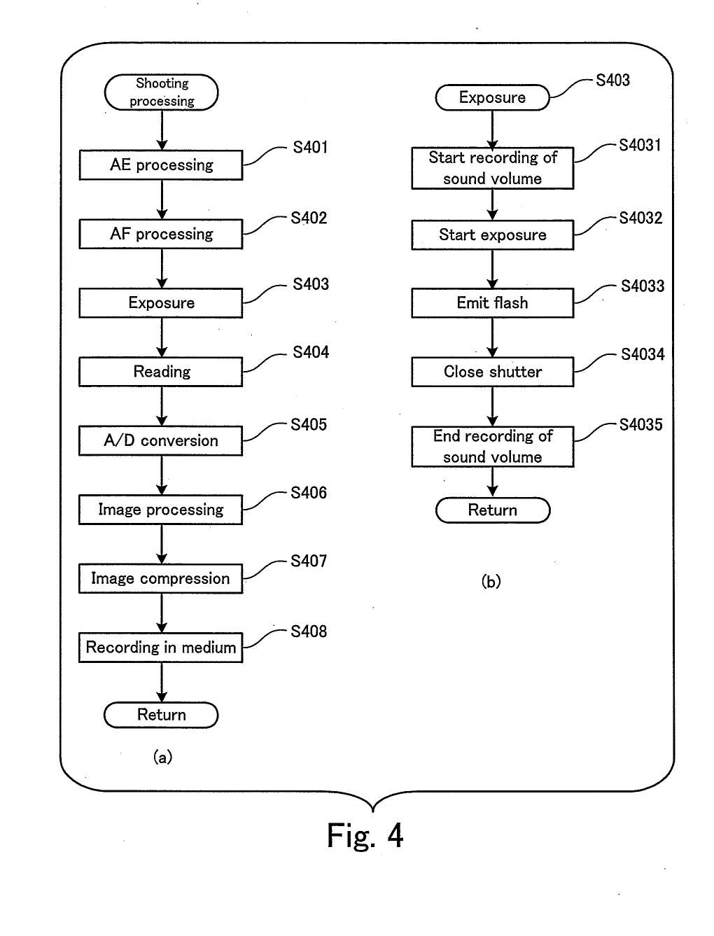

FIG. 4 is a flowchart showing steps of the shooting processing carried out by the CPU 100.

Part (a) of FIG. 4 shows steps of the shooting processing performed when the sound detecting mode is selected, and Part (b) of FIG. 4 shows the details of exposure processing at step S403.

The processing of this flow starts when the release button 10a is half pressed.

AE processing is performed in step S401 that calculates a shutter speed as well as the diameter of the shutter 1102 that also serves as a diaphragm. AF processing is performed in step S402 where the lens driving section 101 is caused to move the focus lens in the shooting lens 1101 to the in-focus position. In the next step S403, the shutter 1102 that also serves as a diaphragm is driven to open and close according to the shutter speed calculated in step S401 so that the imaging element 120 performs exposure. In the next step S404, the imaging element driving section 103 causes the imaging element 120 to output an image by supplying an image reading signal thereto. In the next step S405, the A/D converting section 122 is caused to perform A/D conversion, and then in step S406, the digital signal processing section 123 is caused to perform image processing such as conversion into YC signal. Subsequently, in step S407, the digital signal processing section 123 is caused to perform compression processing and to record the image to which data representing a sound at the time of shooting is added in the memory card 128 that is a medium (step S408), and the processing of this flow ends.

Here, the details of exposure processing at step S403 will be described by referring to Part (b) of FIG. 4.

When exposure starts in step S403, firstly in step S4031, the microphone MK picks up a sound of the object side and starts recording of the sound into the sound recording section within the sound processing section 130. In step S4032, the imaging driving section 103 resets accumulated charges to start exposure and in step S4033, the flash emitting section 190 fires flash when necessary. After a lapse of certain shutter time (second), in the next step S4034, the diaphragm driving section 102 is caused to perform the operation of closing the shutter 1102 that also serves as diaphragm. In step S4035, the sound information is recorded in the sound recording section and returns to step S404 in Part (a) of FIG. 4.

In this way, when the digital camera 1 is configured to be able to record data representing a volume of the sound by associating it with an image, it is possible to search and retrieve an image by making the data representing the volume of the sound as index key when the image is searched during reproduction.

In the above embodiment, the sound processing section 130 is an example of the detecting section according to the present invention and the external memory controlling section 127 is an example of the recording section according to the present invention.

As described above, it is possible to realize an example of the image taking apparatus capable of recording enormous volumes of images with the addition of useful information to each of them for retrieving a required image from among the enormous volumes of images.

Here, in the first embodiment, the description has been made about the example that records a still image with the association of a sound by providing the sound detecting mode. However, more remarkable effect can be obtained by configuring the digital camera to automatically set the sound detecting mode at the time of continuous shooting so that a sound picked up per shooting can be recorded by being associated with a shot image.

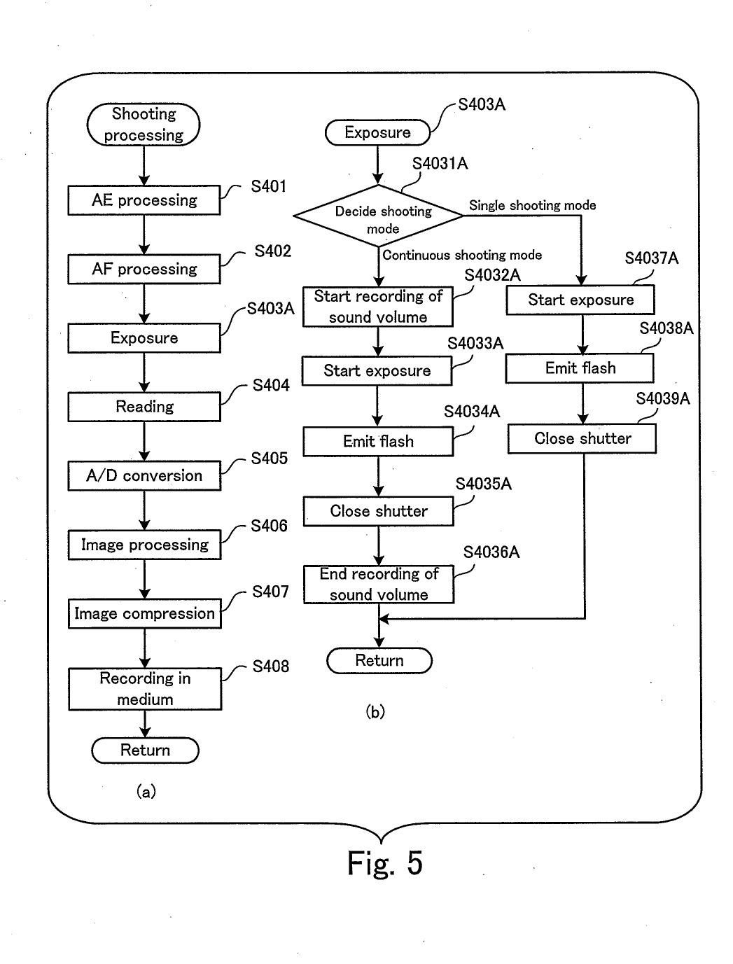

FIG. 5 is a diagram showing a second embodiment.

FIG. 5 illustrates steps of shooting processing in the continuous shooting mode. Also in this second embodiment, it is assumed that there is used a camera similar to the digital camera 1 that has the outlook shown in FIG. 1 and the internal constitution shown in FIG. 2.

The processing in Part (a) of FIG. 5 is the same as the processing in Part (a) of FIG. 4 except for the processing of exposure step and thus, the description will be made only about the exposure step in Part (b) of FIG. 5. Additionally in the continuous shooting mode, the processing in Part (a) of FIG. 5 is repeatedly performed certain times. In addition, as shown in Part (b) of FIG. 5, the sound detection is not performed in the single shooting mode.

When the processing of exposure at step S403A in Part (a) of FIG. 5 starts, a judgment is made about whether the single shooting mode or the continuous shooting mode is selected in step S4031A. If it is judged that the continuous shooting mode is set, then in step S4032A, the recording of a sound starts and in step S4033A, the imaging element driving section 103 resets accumulated charges and starts exposure. In the next step S4034A, the flash emitting section 190 is caused to fire a flash if it is necessary, then, and in step S4035A, the shutter 1102 that also serves as a diaphragm is caused to close after a lapse of certain shutter time (second). In step S4036A, the volume of the voice, that is, the volume of the sound is recorded in the sound recording section, the processing of this flow ends and the flow returns to step S404 in Part (a) of FIG. 5.

In step S4031A, if it is judged that the single shooting mode is selected, then in step S4037A, the imaging element driving section 103 resets accumulated charges to start exposure, and in step S4038A, the flash emitting section 190 is caused to fire a flash if it is necessary, and the shutter 1102 that also serves as a diaphragm is caused to close after a lapse of certain shutter time (second) at step S4039A.

Also in the present embodiment, the sound processing section 130 is an example of the detecting section according to the present invention and the external memory controlling section 127 is an example of the recording section according to the present invention.

When the digital camera is thus configured, it is possible to record enormous volumes of images with the addition of useful information to each of them for retrieving a required image from among the enormous volumes of images so that even though the amount of images through continuous shooting is increased, it is possible to retrieve an image associated with a volume of the sound having not less than a certain volume and to reproduce and display the retrieved image.

Next, processing performed when the operation mode selection switch 10d is switched to the reproducing mode will be described.

As described above, in the continuous shooting mode, the sound detecting mode is automatically set, so that the description will be made with the assumption that during reproduction, a series of images shot in the continuous shooting mode have been taken in the sound detecting mode and images shot in the single shooting mode have been taken in the normal mode.

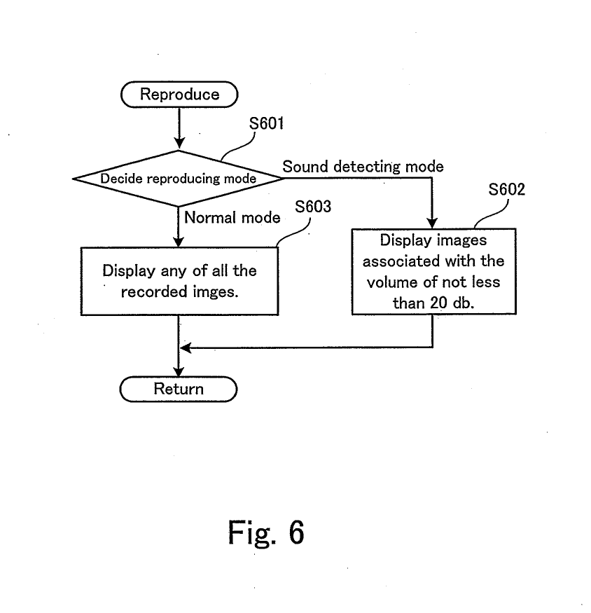

FIG. 6 is a diagram showing a third embodiment.

FIG. 6 illustrates a flowchart showing the reproduction processing the CPU 100 performs when the operation mode selection switch 10d of the digital camera in FIG. 1 is switched to the reproducing mode.

When the operation mode selection switch 10d is switched to the reproducing mode, the CPU 100 starts the processing of the flow in FIG. 6.

In step S601, firstly it is judged whether or not the sound detecting mode is set. If it is judged at this step S601 that the sound detecting mode is set, then the flow proceeds to step S602 and images each associated with a volume of the sound having not less than 20 dB, for example, are retrieved from the memory card 128 and arranged to display on the liquid crystal monitor 125A by directing the display controlling section 124. If it is judged at step S601 that the sound detecting mode is not set, but the normal mode is set, then in step S603, any image in the memory card 128 is displayed on the liquid crystal monitor 125A and the processing of the steps of this flow ends.

In the above embodiment, the CPU 100 is described as an example of the image retrieving section according to the present invention. And as an example of the image acquiring section according to the present invention, there is described the combination of the imaging element 120 in the shooting mode, the analog signal processing section 121, the A/D converting section 122, the digital signal processing section 123, the compression/decompression section 126, the external memory controlling section 127, the recording medium 128, and further, the sound processing circuit 130 and the microphone MK.

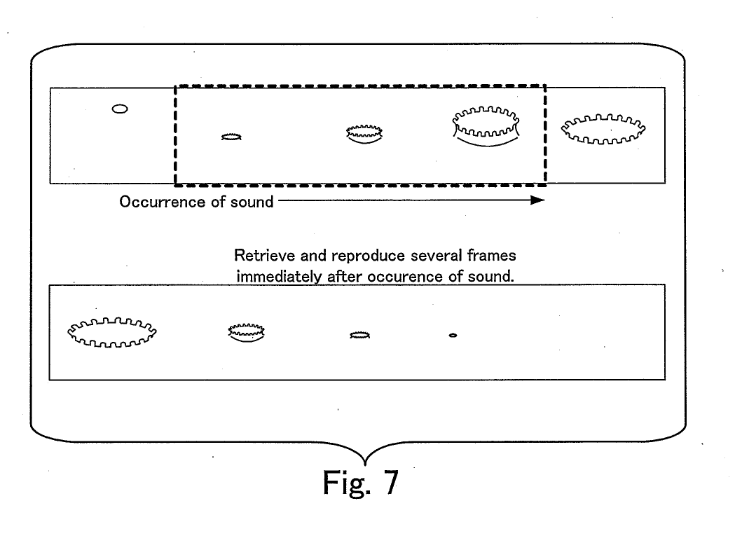

FIG. 7 is a diagram showing reproduced images displayed on the liquid crystal monitor 125 when the processing in FIG. 6 is performed.

FIG. 7 illustrates images of a water drop called as milk crown, which have been continuously taken while it changes its shape. When the continuous shooting mode is set, the shooting is performed in the state that the sound detecting mode is automatically set. Therefore, as shown in FIG. 7, if the processing in FIG. 6 is performed when there are ten shot images that have been continuously taken, all of the images from the first shot are not displayed but the images from the second to the fourth shot (those three images surrounded by dotted lines), which have been taken immediately after the fall of the water drop are displayed.

With this, for example, when a researcher acquires numerous amounts of images as a research material by rapid continuous shooting, this person can reproduce and display only necessary images by isolating them. Additionally, since the recording capacity of a recording medium has also become large, there is no need to delete images that have not been retrieved. If the digital camera is so configured as to be able to reproduce continuously shot images one by one in the normal mode, even though there are enormous amounts of images, the user can carefully check the enormous amounts of images one by one.

Hereinafter, description will be made about other modifications of the present embodiment.

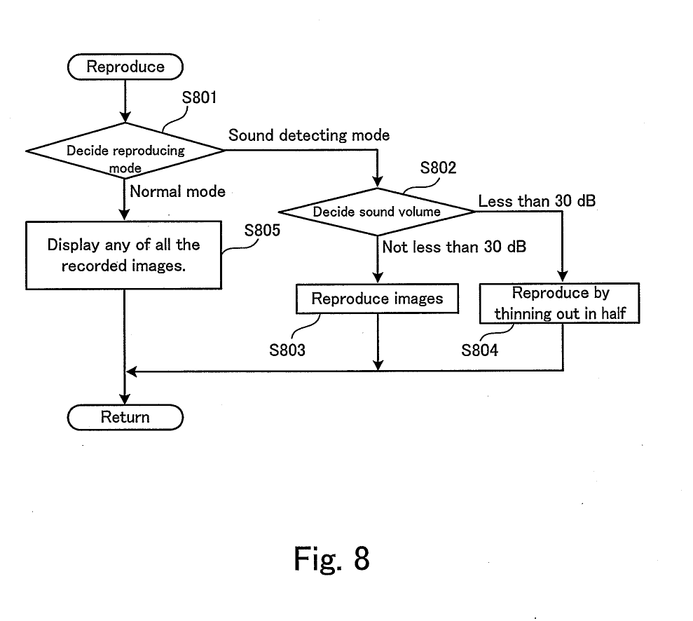

FIG. 8 is a diagram showing processing for displaying images associated with sound data of not less than a certain level in the sound detecting mode as well as for displaying images associated with sound data of less than the certain level by thinning them out in half. Firstly in step S801, a decision is made whether or not the sound detecting mode is set. If it is judged in this step S801 that the sound detecting mode is set, the flow proceeds to step S802 to decide whether or not the volume of the sound is not less than 30 dB. If it is judged in step S802 that the volume is not less than 30 dB, the flow proceeds to step S803 to arrange and display the images. While if it is judged in step S802 that the volume is less than 30 dB, the flow proceeds to step S804 to arrange and display image by thinning out in half. If it is judged in step S801 that the normal mode is set, the flow proceeds to step S805 to reproduce and display images sequentially on the liquid display monitor and the processing of this flow ends.

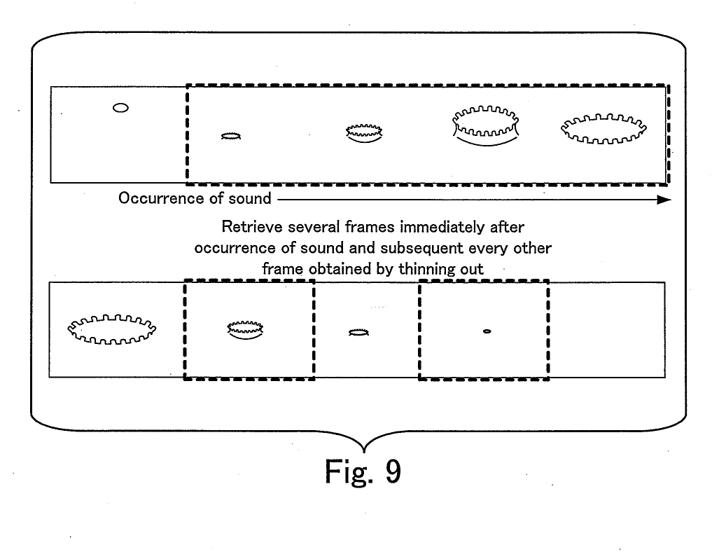

FIG. 9 is a diagram showing one example of the screen displayed on the liquid crystal monitor 125A when the CPU 100 performs the processing in FIG. 8.

The plural images that have been continuously taken in the shooting mode are arranged in the order of shooting, and from among the plural images, images having the sound level of not less than 30 dB (four shots in the upper drawing) are retrieved and displayed on the display screen, and further, images having the sound level of less than 30 dB are thinned out in half, and thus the parts enclosed in dotted lines in FIG. 9 are sequentially arranged and displayed on the liquid crystal monitor.

By displaying as FIG. 9, required images can be displayed on the liquid crystal monitor in the order of shooting from among the numerous volumes of images and the user can check the images that have been continuously shot while viewing a whole picture, since less required images are reduced by thinning out and displayed.

In the embodiments described so far, the volume of the voice, that is, the volume of the sound has been used as the characteristic volume of the sound. However, an average frequency of the sound may be used as the characteristic volume of the sound. As described previously, the sound processing section 130 is equipped with a band pass filter, and furthermore, it is equipped with band pass filters of various bandwidths.

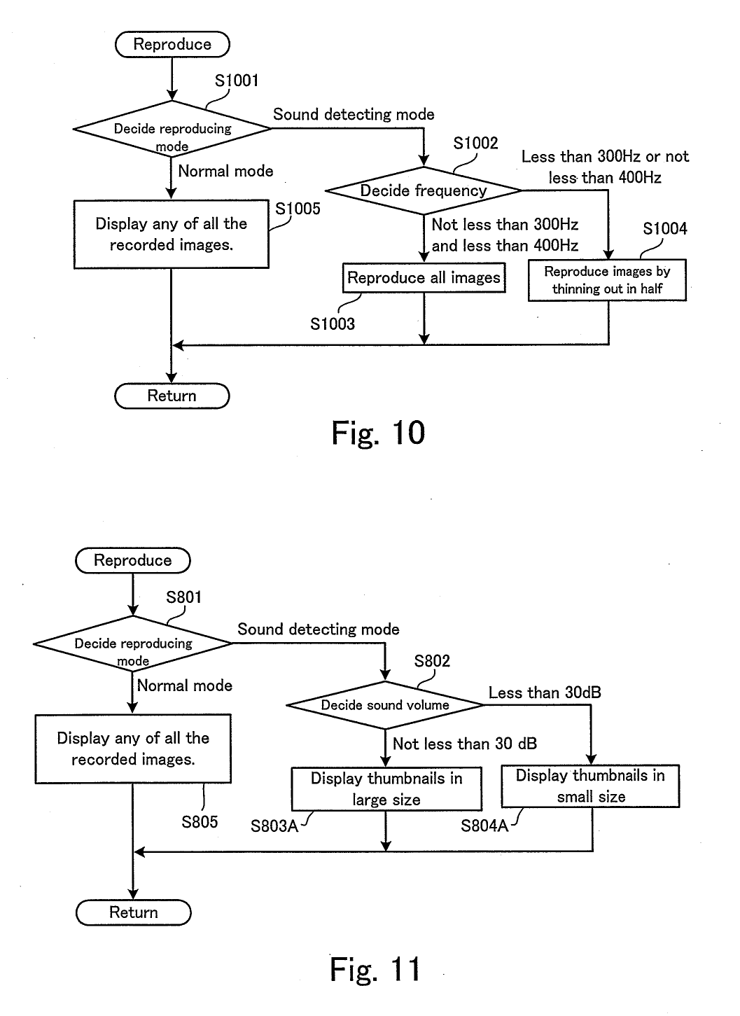

FIG. 10 is a diagram showing processing performed when the frequency of the sound is used as the characteristic volume of the sound. In step S1001, firstly a judgment is made whether or not the sound detecting mode is set. If it is decided in this step S1001 that the sound detecting mode is set, then the flow proceeds to step S1002 to decide whether or not the frequency of the sound is not less than 300 Hz and less than 400 Hz. If it is decided in step S1002 that the frequency is not less than 300 Hz and less than 400 Hz, then the flow proceeds to step S1003 to reproduce and display images having the frequency information, and if it is decided in step S1002 that the frequency is less than 30 dB, the flow proceeds to step S1004 to reproduce and display images by thinning them out in half. If it is decided in step S1001 that the normal mode is set, the flow proceeds to step S1005 to display any of the images recorded in the recording medium on the liquid display monitor and the processing of this flow ends.

Incidentally, in this example, the frequency having not less than 300 Hz and less than 400 Hz has been used as the criteria of judgment, however, the criteria of judgment may be an average frequency of the voice that has been recorded by recording a person's voice by means of a recording function provided in the digital camera. In this way, a frequency may also be used as the characteristic volume of the sound.

FIG. 11 is a diagram showing an example that displays required images in large size and images that are less required in small size.

The flow in FIG. 11 is almost the same as that in FIG. 8, however, the processing of steps S803A and S804A are provided in place of steps S803 and S804, respectively. If the volume of the sound is determined not less than 30 dB in step S802, then in step S803A thumbnail images are displayed in large size, while if the volume of the sound is judged as less than 30 dB in step S802, then in step S804A thumbnail images are displayed in small size.

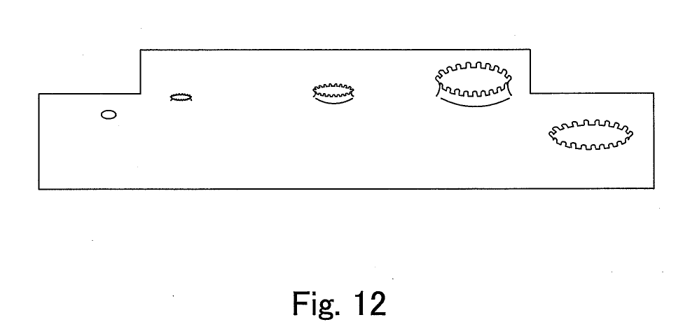

FIG. 12 is a diagram showing how images are displayed on the liquid crystal monitor 125A when the CPU 100 (refer to FIG. 2) performs the processing in FIG. 11. For example, at the time of reproducing the way a water drop called as milk crown changes its shape as shown in FIG. 7, thumbnail images taken immediately after the fall of the water drop are displayed in large size and other images are displayed in small size.

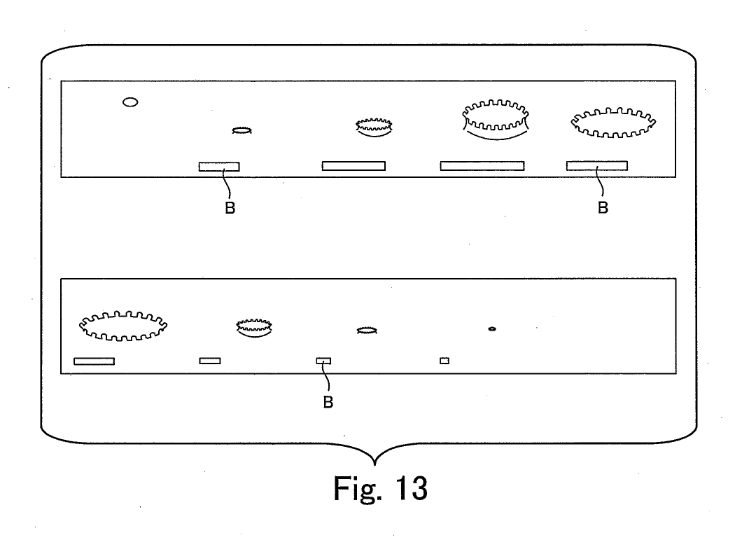

FIG. 13 is a diagram showing a display example when a sound volume bar B is displayed on the liquid crystal monitor along with the continuously shot images.

Since the information representing the volume of the voice, that is, the volume of the sound is added to each shot image in the continuous shooting mode, the sound volume bar B can be displayed, based on the information, under each of the shot image as shown in FIG. 13. In this way, when the sound volume bar B for each frame is displayed along with the continuously shot images, it is easy to understand the situation at the time of continuous shooting, because the state of the sound at the time of shooting is displayed along with the image.

What is claimed is:

1. An image taking apparatus that generates an image of an object by forming the image on an imaging element, the image taking apparatus comprising:
a microphone that picks up a sound at the time of shooting;
a detecting section that detects a characteristic volume of the sound picked up by the microphone at the time of shooting; and
a recording section that records the characteristic volume of the sound detected by the detecting section by associating the characteristic volume with the image.

2. An image taking apparatus that generates image data representing an image of an object by forming the image on an imaging element, the image taking apparatus comprising:
a single shooting mode and a continuous shooting mode;
a microphone that picks up a sound at the time of shooting;
a detecting section that detects a characteristic volume of the sound picked up by the microphone; and
a recording section that records, in the continuous shooting mode, a characteristic volume of a sound acquired by the detecting section per shooting while a plurality of images are continuously shot, by associating the characteristic volume with each of the plurality of images shot continuously.

3. The image taking apparatus according to claim 1, wherein the detecting section detects a volume of the sound picked up by the microphone as the characteristic volume.

4. The image taking apparatus according to claim 2, wherein the detecting section detects a volume of the sound picked up by the microphone as the characteristic volume.

5. The image taking apparatus according to claim 3, further comprising a display screen and a volume displaying section that displays on the display screen a volume of the sound detected by the detecting section at the time of shooting.

6. The image taking apparatus according to claim 4, further comprising a display screen and a volume displaying section that displays on the display screen a volume of the sound detected by the detecting section at the time of shooting.

7. The image taking apparatus according to claim 1, wherein the detecting section detects an average frequency of the sound picked up by the microphone as the characteristic volume.

8. The image taking apparatus according to claim 2, wherein the detecting section detects an average frequency of the sound picked up by the microphone as the characteristic volume.

9. An image reproduction apparatus comprising:
an image acquiring section that acquires an image; and
a display screen that displays the image acquired by the image acquiring section,
wherein the image acquiring section acquires a plurality of images each associated with each characteristic volume of a sound, and
the image reproduction apparatus further comprises:
an image retrieving section that retrieves an image from among the images acquired by the image acquiring section based on the characteristic volume associated with the image, and
an image reproducing section that displays on the display screen the image retrieved by the image retrieving section.

10. The image reproduction apparatus according to claim 9, wherein the image displaying section arranges a plurality of images acquired by the image acquiring section in the order of shooting, displays on the display screen images retrieved by the image retrieving section from among the plurality of images, and also displays images obtained by thinning-out of images that are not retrieved by the image retrieving section.

11. The image reproduction apparatus according to claim 9, wherein the image displaying section displays images retrieved by the image retrieving section from the plurality of images acquired by the image acquiring section, and also displays images that are not retrieved by the image retrieving section in a size smaller than the retrieved images.

12. The image reproduction apparatus according to claim 9, wherein the image acquiring section acquires a plurality of images with each of which a volume of a sound is associated as the characteristic volume of the sound, and the image retrieving section retrieves an image based on the volume of the sound.

13. The image reproduction apparatus according to claim 9, wherein the image acquiring section acquires a plurality of images with each of which an average frequency of a sound is associated as the characteristic volume of the sound, and the image retrieving section retrieves an image based on the average frequency of the sound.

14. The image reproduction apparatus according to claim 13, wherein the apparatus further includes a sound setting section that sets, according to a user operation, an average frequency of a sound that becomes a base for retrieving an image in the image retrieving section.
